(19) United States
(12) Patent Application Publication
(10) Pub. No.: US 2018/0051513 A1
(43) Pub. Date: Feb. 22, 2018

(54) Operator's Deck and Ladder Assembly for an Articulated Harvesting Combine

(71) Applicant: Tribine Industries LLC, Logansport, IN (US)

(72) Inventors: Robert A. Matousek, Valley Center, KS (US); Martin E. Pruitt, Hesston, KS (US); Dillon M. Thompson, Newton, KS (US)

(73) Assignee: Tribine Industries LLC, Logansport, IN (US)

(21) Appl. No.: 15/654,786

(22) Filed: Jul. 20, 2017

Related U.S. Application Data
(60) Provisional application No. 62/375,986, filed on Aug. 17, 2016.

(51) Int. Cl. E06C 5/06; E06C 7/18

(52) U.S. Cl. CPC E06C 5/06; E06C 5/42; E06C 7/187

(57) ABSTRACT

Disclosed is a harvesting combine having a cab for an operator, a wheel assembly adjacent to a stairs assembly having a top and a bottom, and an improved stairs assembly for accessing the cab by the operator. The improved stairs assembly in a deployed state is angled outwardly from the top of the stairs assembly. The stairs assembly is rotatably connected about its bottom to both raise the stairs assembly and move its bottom inwardly. The stairs assembly is movably connected by a track assembly about its top so as to permit the top of the stairs assembly to move inwardly and upwardly when the stairs assembly is raised from its deployed state. The stairs assembly may be angled outwardly from the top end of the stairs assembly to an angle from the vertical of greater than 15° and may be rigidly anchored at its lower end.

### CROSS-REFERENCE TO RELATED APPLICATIONS

This application is cross-referenced to application Ser. No. 14/946,827 filed Nov. 20, 2015; Ser. No. 14/946,842 filed Nov. 20, 2015; Ser. No. 14/967,691 filed Dec. 14, 2015; Ser. No. 15/621,218 filed Jun. 13, 2017; Ser. No. 15/623,619 filed Jun. 15, 2016; Ser. No. 15/621,218 filed Jun. 13, 2017; Ser. No. 15/636,728 filed Jun. 29, 2016; and Ser. No. 032, filed Aug. 1, 2017.

### STATEMENT REGARDING FEDERALLY SPONSORED RESEARCH AND DEVELOPMENT

Not applicable.

### BACKGROUND OF THE INVENTION

The present disclosure relates to harvesting combines, optionally articulated (jointed), and more particularly to an improved method of ingress and egress for the operator.

On modern combines, the operator's cab (sometimes called operator's station) is located above the feeder house in front of the grain bin and between the large front-axle propel tires. This arrangement has served well for many decades when the size and weight of the machines were small compared to today's very large and heavy machines. The added weight to today's machines required that the size of the tires to correspondingly increase to reach capacities that allowed safe operation of the heavy vehicle. Since the overall configuration of the cab and the operator's platform outside the cab more or less required that the platform span over the tires so that the ladder could hang down outside of the tires for safe use. When dual tires became required to meet the weight an flotation requirements of modern large combines, the width of the platform from the cab to the ladder also increased outwardly even a greater distance.

Since these combine designs have no fixed structural member that lies forward of the front tires, the platform was essentially cantilevered from the side of the separator over the wide dual tires to the ladder. This cantilevered condition of the ladder mount, combined with the cantilevered attachment of the ladder at its top to the platform actually predetermined that the ladder respond more like a springboard than a solid ladder. In order to reduce this total cantilever as much as structurally possible, the design of the ladder was universally found to be nearly vertical.

The net of all these requirements and structural improprieties is that an operator finds he must climb a nearly vertical ladder that always feels like it is about to break off the machine. Additionally, when the header is removed from the machine and the machine travels on a road, the ladder located outside of the tires makes a very wide machine even dangerously wider. To avoid this extra width, designers have schemed to make the ladders lift, pivot, turn, or otherwise move around such that they do not make the machine wider. The ladder in this transport configuration is not usable by the operator and must be deployed at some effort in order to get up or down from the platform. And the schemes that make the ladder move out of the way, inevitably result in rendering the assembly even more unstable. The final insult in this ordeal is that in order to legally ship these machines on a freight truck, the operator's platform extensions and the ladder must be completely removed to get the load down to a legal width for a highway load, which is never a simple task.

Thus, there is a need for an improved platform and ladder assembly for safe operator ingress and egress, for transport on a freight truck, and for driving the combine over a public road. It is to these considerations that the present disclosure is addressed.

### BRIEF SUMMARY OF THE INVENTION

Disclosed is a harvesting combine having a cab for an operator, a wheel assembly adjacent to a stairs assembly having a top and a bottom, and an improved stairs assembly for accessing the cab by the operator. The improved stairs assembly in a deployed state is angled outwardly from the top of the stairs assembly. The stairs assembly is rotatably connected about its bottom to both raise the stairs assembly and move its bottom inwardly. The stairs assembly is movably connected by a track assembly about its top so as to permit the top of the stairs assembly to move inwardly and upwardly when the stairs assembly is raised from its deployed state. The bottom of the stairs assembly may be extended outwardly from the vertical to an angle of greater than 15°.

An extendable link is connected about the lower end of the stairs assembly to move the lower end of the stairs assembly outwardly to its deployed state for the rigid anchoring of the lower end of the stairs assembly in its deployed state.

### BRIEF DESCRIPTION OF THE SEVERAL VIEWS OF THE DRAWINGS

For a fuller understanding of the nature and advantages of the present method and process, reference should be had to the following detailed description taken in connection with the accompanying drawings, in which:

FIG. 1 is a side view of the articulated harvesting combine fitted with the disclosed straw chopper and distribution assembly disclosed herein;

FIG. 2 is a top view of the articulated harvesting combine of FIG. 1 showing the pattern of distributed chopped straw therefrom;

FIG. 3 is an isometric view of the left side of the articulated harvesting combine of FIG. 1;

FIG. 4 is a bottom isometric view of the left rear end of the forward unit of the articulated harvesting combine of FIG. 1 showing the exit opening for the chopped straw;

FIG. 5 is a bottom isometric view of the right rear end of the forward unit of the articulated harvesting combine of FIG. 1 showing the exit opening for the chopped straw;

FIG. 6 an isometric view of the PPU with grainhead removed to show the disclosed stairs assembly;

FIG. 7A is a front view and FIG. 7B is a side view of the disclosed stairs assembly in a down position for ingress/egress of the PPU operator;

FIG. 8 is an isometric view of the disclosed stairs assembly in an up (home or stored) position;

FIG. 9 a side view of the disclosed stairs assembly in an up or home position;

FIG. 10 is a front view of the disclosed stairs assembly in an up or home position;

FIG. 11A shows just the disclosed stairs assembly in both an extended or working position;

FIG. 11B shows just the disclosed stairs assembly in both a retracted or home position;

FIG. 12 is an isometric view of the piston assembly for moving the stairs assembly where the stairs assembly is in a down position;

FIG. 13 is an isometric view of a single piston assembly for moving the stairs assembly where the stairs assembly is in an up position;

FIG. 14 is an enlarged isometric view of the disclosed stairs assembly showing the V-shaped trough of the platform that accepts the round protrusion of the ladder that together serve to prevent the ladder from falling downward;

FIG. 15 is an enlarged isometric view of the disclosed stairs assembly showing the V-shaped trough of the platform with the round protrusion of the ladder captured by the trough;

FIG. 16 is an isometric front view of the linear actuator of correct length to lift and lower the ladder for the disclosed ladder assembly;

FIG. 17 is an isometric rear view of the linear actuator of correct length to lift and lower the ladder for the disclosed ladder assembly;

FIG. 18 is an isometric view of a dual piston assembly for moving the stairs assembly where the stairs assembly is in a down position; and

FIG. 19 is an isometric view of a dual piston assembly for moving the stairs assembly where the stairs assembly is in an up position.

The drawings will be described in greater detail below.

### DETAILED DESCRIPTION OF THE INVENTION

The significant change of architecture of the disclosed harvesting combine allows a designer to address even the most routine configurations as described in the background above, and design toward the following improvements:
1. Attachment such that the ladder is not or does not feel like it is a springboard.
2. Ladder orientation such that the platform does not have to reach out past the outside of the tire.
3. A weight distribution that does not require dual tires at any conceivable vehicle weight that the front axle could be expected to carry so that overall width can be reduced.
4. Reasonable and practical (simple) support back to the major structure that positively removes the springboard feeling from the ladder climb.
5. An angled orientation of the ladder making it less vertical and feel more like a typical staircase.
6. The ability to meet all of the above criteria, but still not have any structure outside of the tire width, making it reasonable to have no reconfiguration for typical road travel.
7. An easily operated means of moving the ladder into a raised and lifted position for freight truck transport that will allow the ladder to be quickly and easily moved into such a position.
   a. A design such that such a position could also be achieved very quickly if desired for field operation for whatever reason, but mostly for ground clearance.
8. A location and orientation in front of the tires such that the operator does not risk falling into the tire path under reasonable use circumstances; yet, still allow that the ladder protrusion does not add to machine overall width (ladder inside of the tire width).

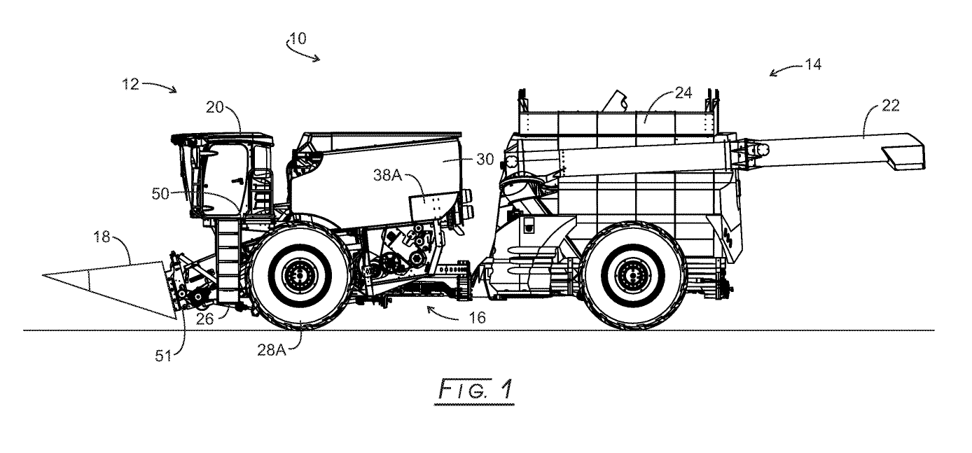

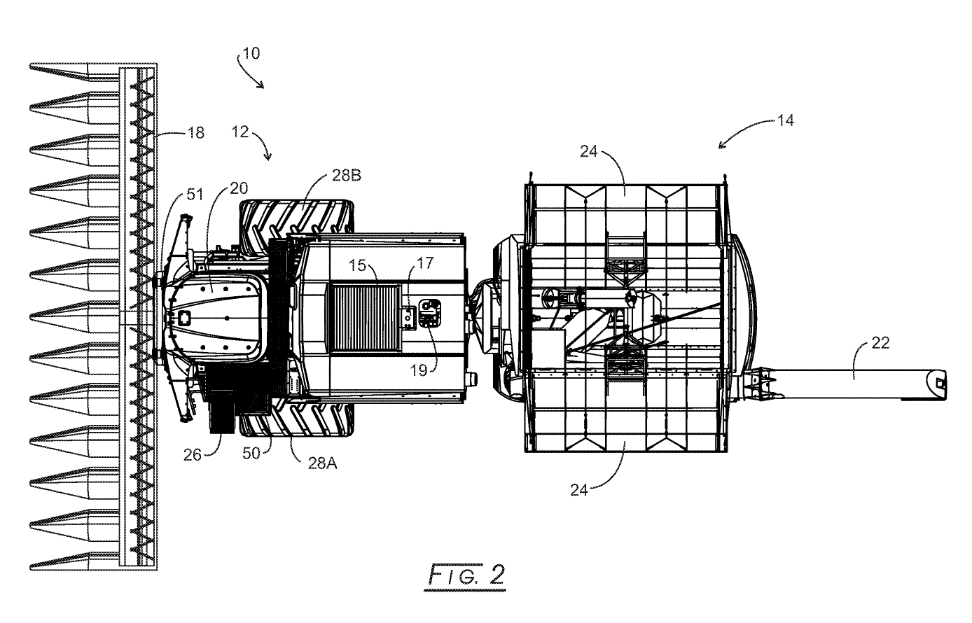

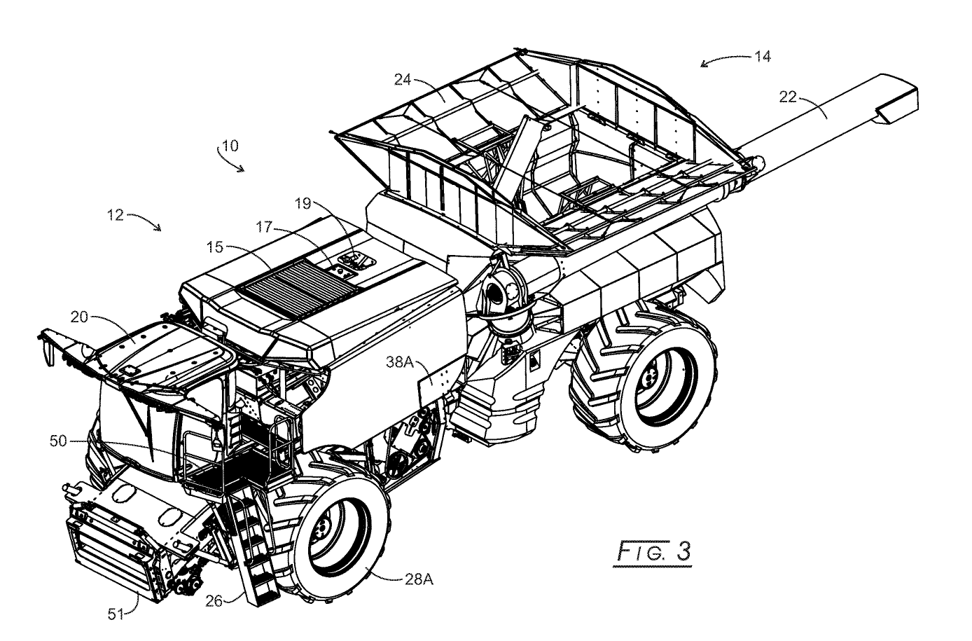

Referring now to the drawings and specifically referring initially to FIGS. 1, 2, and 3, an articulated harvester, 10, consists of a powered PPU, 12, a rear grain cart, 14, and an articulation joint, 16, that connects PPU 12 with rear grain cart 14. The details of articulation joint 16 are disclosed in commonly owned application Ser. No. 14/946,827 filed Nov. 20, 2015. PPU 12 carries a grainhead, 18, supported by a feeder house, 51, operator's cab, 20, grain cleaning and handling assembly, and engines. PPU 12 is devoid of any grain storage, such being exclusive in rear grain cart 14. While both PPU 12 and rear grain cart 14 are shown being carried by wheel assemblies, one or both could be tracked. A screened air inlet, 15, is located atop PPU 12 where the air likely is the cleanest around harvesting combine 10. A radiator cap, 17, and engine exhaust, 19, are located behind screened air inlet 15. The arrows in FIG. 2 show the distribution of chopped straw, 21, created by the disclosed straw chopper assemblies. It will be observed that the distribution is at least as wide as grainhead 18, as desired, and the distribution is relatively even across the entire wide of chopped straw 21.

An off-loading auger assembly, 22, is in the folded home position and being carried by rear grain cart 14. Grain cart 14 also bears a foldable roof, 24, shown in an open position, but which can fold inwardly to cover grain stored in rear grain cart 14. Foldable roof 24 may be made of metal, plastic, or other suitable material, but may be made of durable plastic for weight reduction and easy folding/unfolding. A grain storage bin is carried by grain cart 14 may be made of plastic also in keeping with desirable weight reduction; although, it could be made of metal also at the expense of weight. All plastic parts may be filled with particulate or fiber reinforcement in conventional fashion and could be laminate in construction. Further details on rear grain cart 14 can be found commonly owned application Ser. No. 14/946,842 filed Nov. 20, 2015.

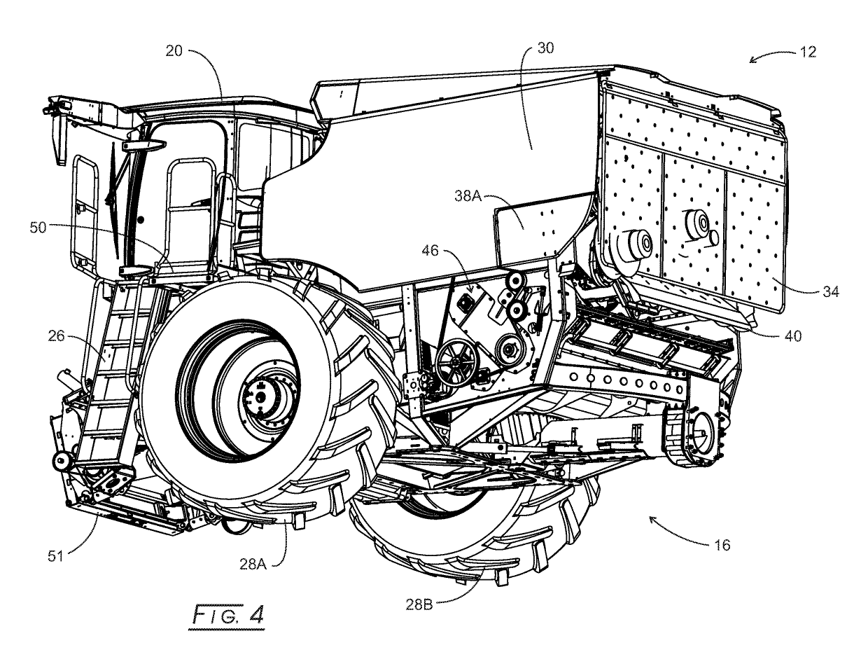

Referring now also to FIG. 4, the operator is granted access to cab 20 by a stair assembly, 26, as more fully described below. PPU 12 is supported by wheel assemblies, 28A and 28B (FIG. 2). Movable side panels, 30 and 31 (see FIG. 5), grants access to the operator or mechanic to the internal mechanisms housed with in PPU 12 from stair assembly 26 and a platform, 50, and retains a foldable platform movable from a vertical home position while the panels are in place to a horizontal active position when the panels are moved away. Such foldable platform mates with platform 50. The movable side panel is more particularly disclosed in commonly owned application Ser. No. ______, filed ______ (62/376,512 filed Aug. 18, 2016; attorney docket no. DIL 2-037).

In FIGS. 4 and 5, a rear panel, 34, covers the back of PPU 12. Panels 30, 31 (see FIG. 5), and 34 only extend downwardly to cover about one-half of the height of PPU 12, allowing access to the exposed internal components for repairs, maintenance, and like occasions. Towards the rear of both panels 30 and 31 are MOG (or for present purposes, chopped straw) outlets, 36A and 36B, respectively, having top deflector plates, 38A and 38B, respectively. These deflector plates are adjustable for determining the location for depositing MOG expelled from the straw chopper assemblies, as will be further detailed below. MOG discharged from the rear of PPU 12 strikes a deflector, 40 (see FIG. 5), to direct the MOG downwardly and not at grain cart 14. Six extensions bearing sensors are located just before hood 40 and provide additional grain loss data to the operator.

Various drive, sprocket, wheel, and belt assemblies, 46 (FIG. 4) and 48 (FIG. 5), power and operate the bonus sieves assemblies disclosed in U.S. Ser. No. 15/649,684, filed Jul. 14, 2017 and will, accordingly, not be described herein. Suffice it to say that the MOG flow from the rotor (concaves and grates) is passed to the bonus sieves that are located in the rear outer space of PPU 12, which space is open due to the lack of rear wheel assemblies. Such bonus sieves assemblies permit all MOG recycle to be passed back to the bonus sieves assemblies and not to the concaves or grates. An additional airflow is provided for the bonus sieves assemblies, which also could be used in the disclosed straw chopper assemblies.

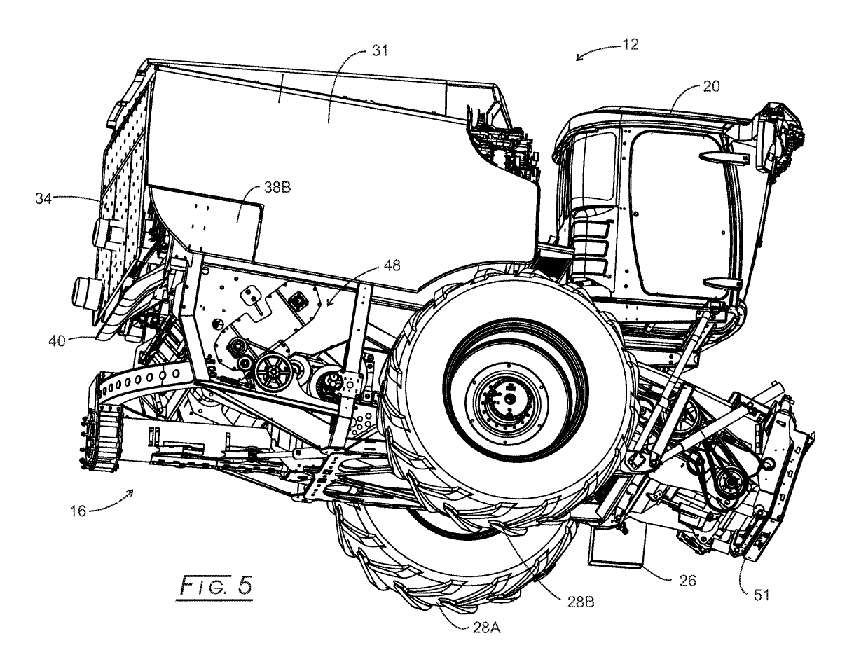

The general layout of stairs assembly 26 can be seen in FIGS. 6, 7A, and 7B. It will be observed that the entire stairs assembly is located forward of wheel assembly 30A and also does not extend beyond its outer width. It will be observed additionally that stairs assembly 26 angles outwardly from its top to its bottom much like conventional stairs making it easy for the operator to use. The bottom of stairs assembly 26 is just off the ground so that it will not be damaged during movement of combine 10. Such distance above the adjacent ground, however, is such that the operator can easily access the bottom rung. From its vertical home position, the bottom of stairs assembly 26 moves outwardly greater than about 15° from the vertical. Such angle is less than other harvesting combines making it easier and safer for the operator to ascend and descend on the disclosed stairs assembly.

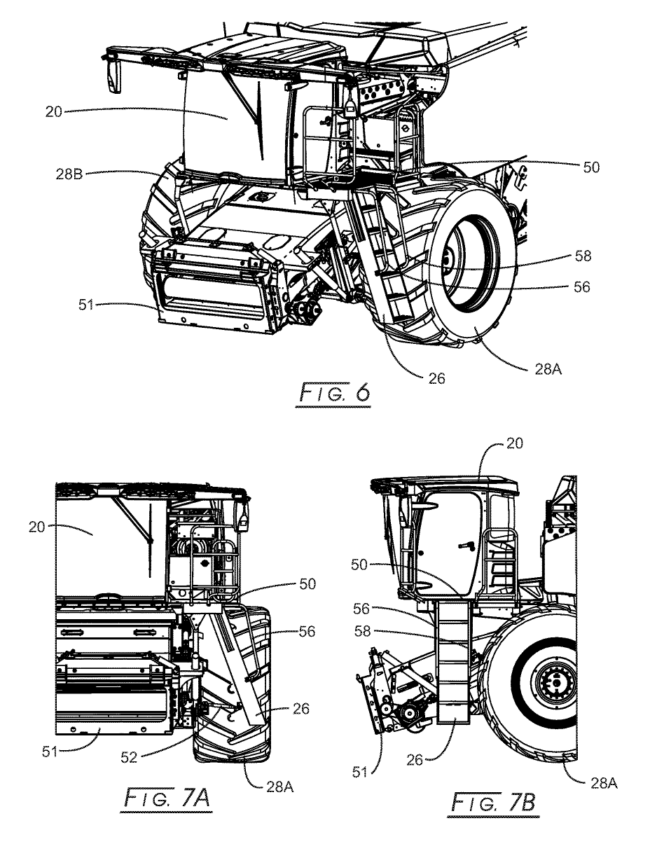

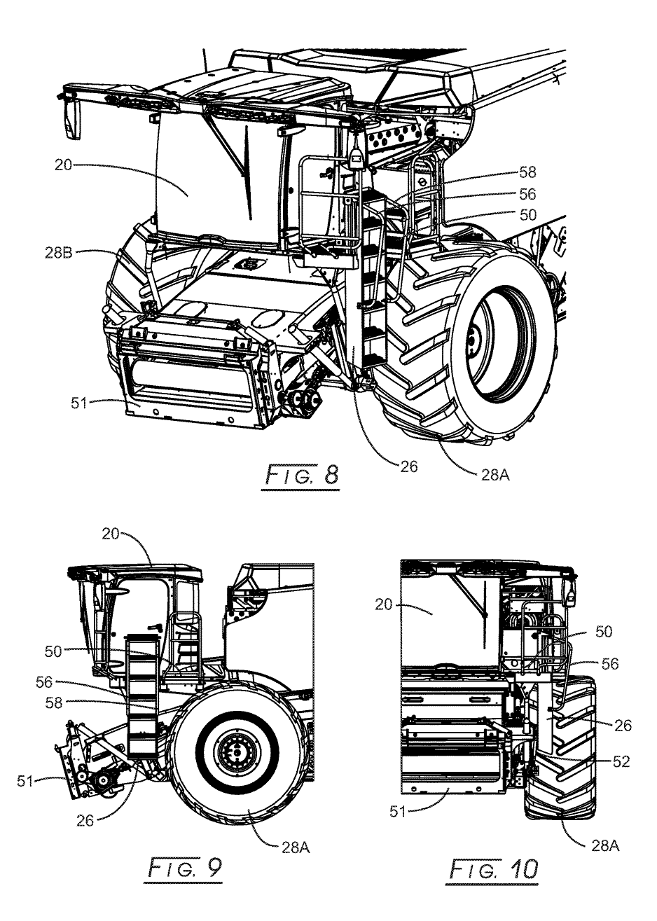

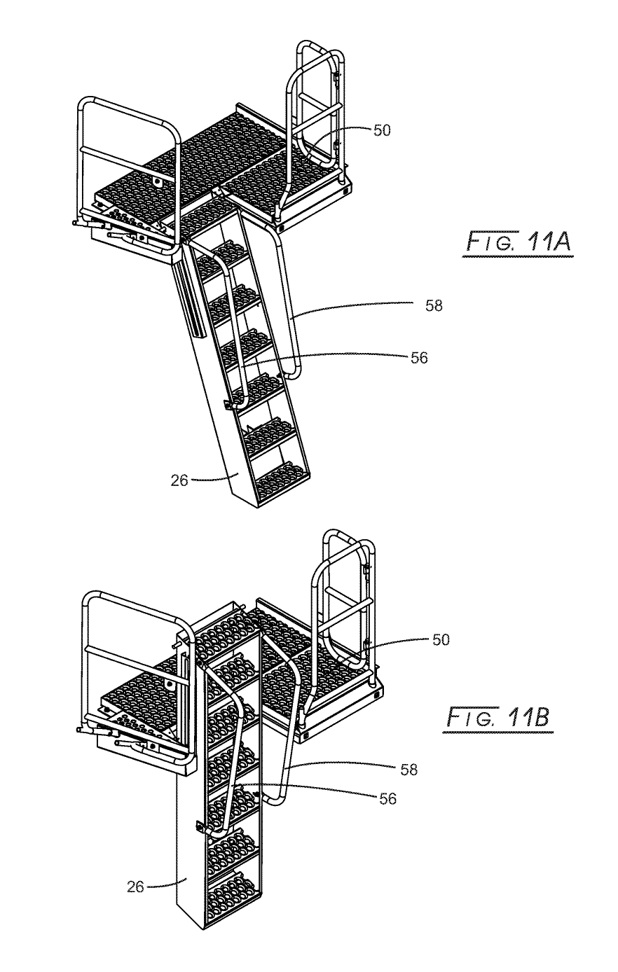

Stairs assembly 26 is shown in an up or home position in FIGS. 8-10. It will be observed that stairs assembly 26 in its stowed position is essentially vertically oriented. In such vertical orientation, the ladder does not interfere with normal operation of combine 10. The upper section of stairs assembly 26 also serves as a fence or barrier preventing the operator from falling off of the platform, 50. FIGS. 11A and 11B illustrate this feature in greater detail. It will be observed in FIG. 11B that stairs assembly 26 has been moved both upwardly and inwardly from its extended position, as shown in FIGS. 6-7B. The stowed position of stairs assembly 26 ensures truck transport of combine 10 within permissible 12 feet width for US roads with minimal permitting.

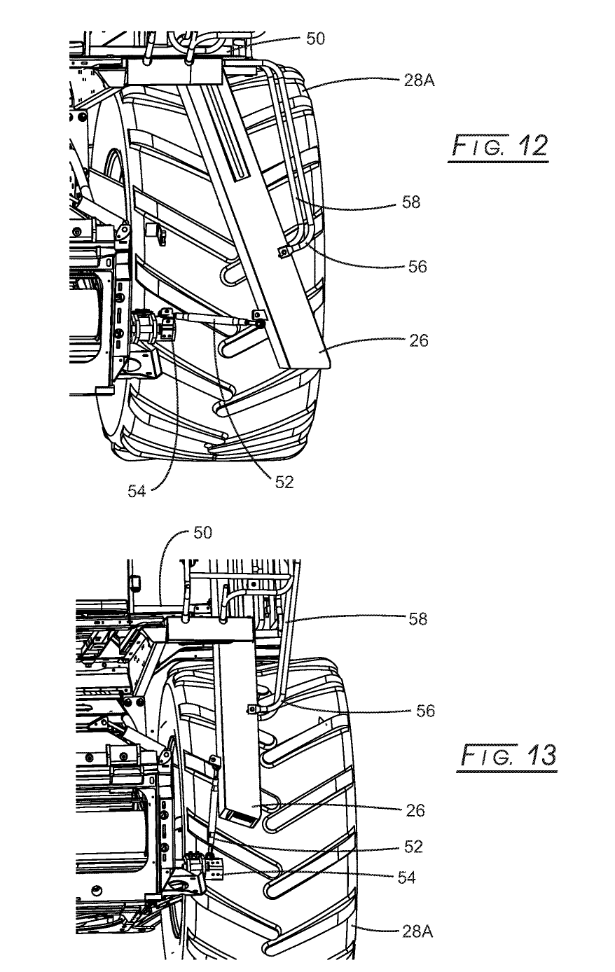

In FIGS. 12 and 13, a lower link, 52 (actually Cat 1 tractor 3^{rd} link turnbuckle), pivotally connects the bottom of stairs assembly 26 to a bar, 54, at the lower front of PPU 12. The pivotal connection at both ends of lower link 52 enables an arc of travel of the bottom of stairs assembly 26 is extended and retracted. Lower link 52 also anchors the bottom of stairs assembly 26 to prevent unintended movement. The angle of stairs assembly 26 from the vertical can be adjusted by the extent to which lower link 52 (e.g., piston assembly) is extended. Finally, it will be observed that a pair of handrails, 56 and 58, and located on either side of stairs assembly 26.

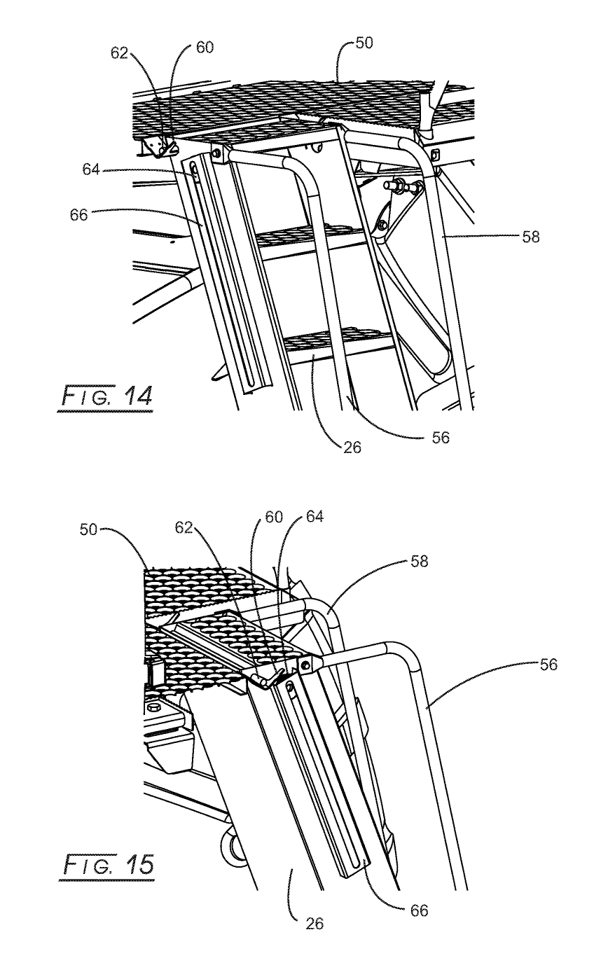

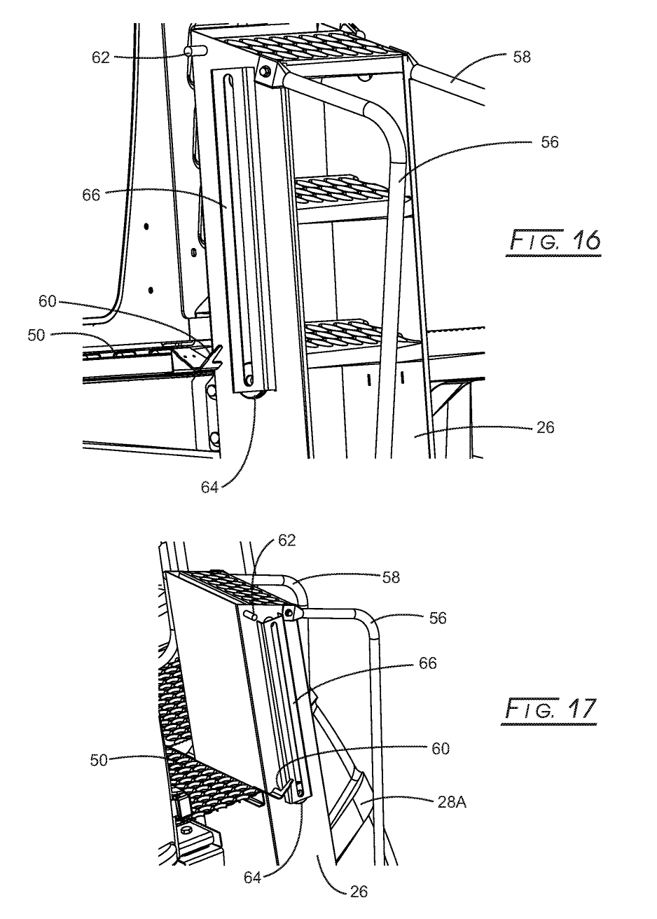

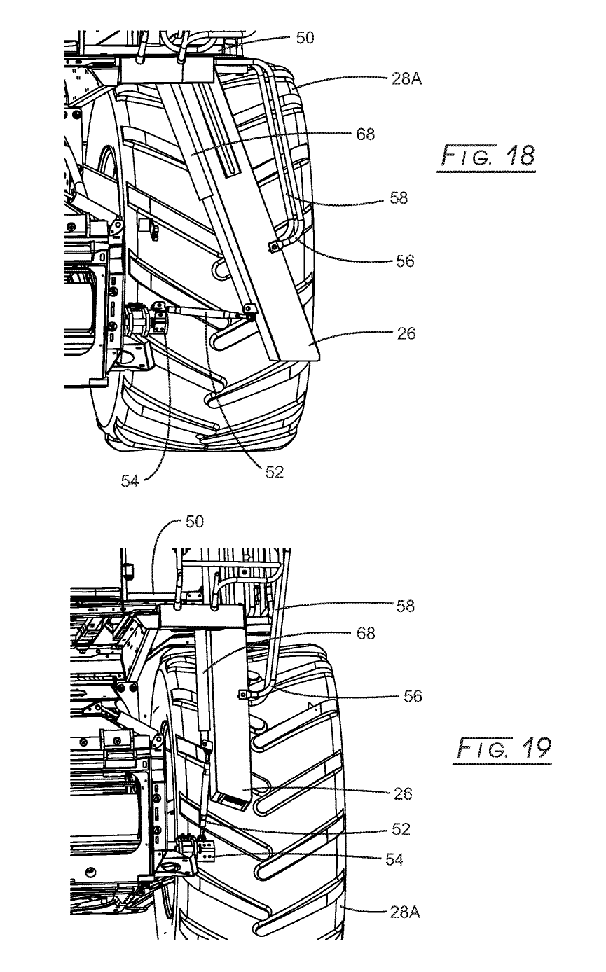

FIGS. 14 and 15 provide cutaway views of the top of stairs assembly 26 that serve as its suspension via V or U-shaped extension, 60, in which a pin, 62, affixed to stairs assembly 26 rests. To reduce friction during deployment and stowing of stairs assembly 26, a roller, 64, runs within a track assembly, 66. Roller 64 desirably will be made of plastic for additional friction reduction. While stairs assembly 26 can be manually deployable, FIGS. 18 and 19 disclose power deployment using a linear actuator, 68, for deploying and stowing stairs assembly 26.

While the apparatus, system, and method have been described with reference to various embodiments, those skilled in the art will understand that various changes may be made and equivalents may be substituted for elements thereof without departing from the scope and essence of the disclosure. In addition, many modifications may be made to adapt a particular situation or material in accordance with the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

1. In a harvesting combine having a cab for an operator, the improved stairs assembly for accessing the cab by the operator, the stairs assembly having a top end and a lower end and having a home state and a deployed state, which improvement which comprises:
(a) in the deployed state, the stairs assembly is angled outwardly from the top end of the stairs assembly to an angle from the vertical of greater than 15°;
(b) the stairs assembly being movably connected by a track assembly about its top end so as to permit the top end of the stairs assembly to move inwardly and upwardly when the stairs assembly is raised from its deployed state to its home state; and
(c) a rotatable and extendable link being connected about the lower end of the stairs assembly to both move the lower end of the stairs assembly outwardly to its deployed state and to raise the stairs assembly inwardly and upwardly to its home state.

2. The improved harvesting combine of claim 1, additionally comprising a platform located between the cab and the improved stairs assembly.

3. The improved harvesting combine of claim 1, wherein the rotatable and extendable link comprises a piston assembly.

4. The improved harvesting combine of claim 1, wherein the stairs assembly is angled outwardly from the top end of the stairs assembly to an angle from the vertical of greater than 15°.

5. The improved harvesting combine of claim 1, wherein a track parallel to the ladder runs along its upper end and wheels attached to the stairs assembly are captured within the track.

6. The improved harvesting combine of claim 2, wherein a V-shaped extension is carried by the platform and the upper end of the stairs assembly carries a pin matable within the V-shaped extension to support the stairs assembly in a deployed state.

7. In a harvesting combine having a cab for an operator, the improved stairs assembly for accessing the cab by the operator, the stairs assembly having a top end and a lower end and having a home state and a deployed state, which improvement which comprises:
an extendable link connected about the lower end of the stairs assembly to move the lower end of the stairs assembly outwardly to its deployed state for the rigid anchoring of the lower end of the stairs assembly in its deployed state.

8. The improved harvesting combine of claim 7, wherein the extendable link comprises a piston assembly.

9. The improved harvesting combine of claim 7, wherein the extendable link piston assembly also raises the stairs assembly inwardly and upwardly to its home state.
